(19) United States
(12) Patent Application Publication
(10) Pub. No.: US 2007/0124399 A1
(43) Pub. Date: May 31, 2007

(54) Dynamic Content System and Method

(75) Inventors: Adam T. Gillespie, San Diego, CA (US); Daniel T. Smith, La Mesa, CA (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 11/565,604

(22) Filed: Nov. 30, 2006

Related U.S. Application Data
(60) Provisional application No. 60/741,534, filed on Nov. 30, 2005.

(51) Int. Cl. G06F 15/16

(52) U.S. Cl. 709/206

(57) ABSTRACT

In accordance with one embodiment of the invention, a computerized dynamic content system and method for use on the internet or other network is described. The ability to communicate personally with customers about products and services they are interested in is one of the most important advantages internet marketing offers over traditional channels. Dynamic content system and method makes mail messaging personal and relevant. The features enable easy, profitable engagement with customers using content, images and offers that correspond to their interests and behaviors. Moreover, dynamic content functionality lets the user send personalized messages to each group using a single email template. If customers and subscribers fall into multiple groups, a user or business user may choose to send them all content that is relevant or select which content gets served by order of importance. In addition they may develop content that matches the interests of subscriber lists. Dynamic content system and method also updates automatically as needs of the users and the demographics of the subscriber lists change.

### RELATED APPLICATIONS

This application claims the benefit of U.S. Provisional Application No. 60/741,534 filed 30 Nov. 2005, entitled “Dynamic Content,” which is incorporated herein by reference.

This application is related to co-pending:
U.S. patent application Ser. No. 11/______, filed Nov. 30, 2006, entitled “Subscriber List System and Method”;
U.S. patent application Ser. No. 11/______, filed Nov. 30, 2006, entitled “Recurring Message System and Method”; and
U.S. patent application Ser. No. 11/______, filed Nov. 30, 2006, entitled “Sub Accounts System and Method”, all of which are herein incorporated by reference.

### FIELD OF THE INVENTION

The present invention relates to electronic mail messaging campaign systems for use on the internet. More particularly, the present invention relates to a system and related tools for creating and maintaining dynamic content.

### BACKGROUND OF THE INVENTION

Targeting customers with e-mail marketing is like going on a date. The electronic commerce (e-commerce) company makes the customer comfortable by providing information, and the customer tries to understand what the e-commerce company is all about. If the customer likes the e-commerce company there is a second date, and then eventually marriage.

E-commerce companies love e-mail, and for good reason. Production costs are low; results are immediate. Personalized e-mail are messages that consumers sign up to receive or that companies can target at customers based on their previous purchases. Furthermore, targeted e-mail marketing requires a much bigger investment than simply blasting out untargeted e-mail messages because it involves sophisticated databases and statistical modeling.

Targeted e-mail is also more prone to error. Sending a personalized message to the wrong person can ruin a relationship for life. So can a message that overloads a customer's computer. But as long as the e-commerce company chooses the right words and format, experts agree that talking to customers is not only good for sales but also good for name recognition. Any excuse to interact with your customer is healthy for the brand, and targeted e-mail seems to be one of healthiest direct-marketing ways to build brand equity.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes may be called an email campaign.

Present email campaigns may suffer from difficulties in locating a pool of relevant individuals to be contacted. In a small email campaign, each email sent is critical to the success of the campaign, and needs to be carefully created. In other situations, large numbers of individuals to be contacted may have been found. This may result in increased difficulty in tailoring the large number of required email messages to the individuals for more effective contact.

Furthermore, once an email campaign has been initiated, difficulties in measuring success of the email campaign are presented. Effective ways for determining whether email recipients have received email from the email campaign have been sought. Also, effective ways for allowing the email recipients to provide feedback have also been sought. It is desirable for the email recipients to be able to respond with feedback, and for the quantity and content of the responses to be monitored and tracked. Furthermore, conducting advanced database search queries, then saving and managing these searches automatically is desirable as well.

Respecting subscribers to an email is also important. A message that's too focused risks missing out on impulse or crossover buys. According to a recent survey by Return Path, the number of consumers who are reporting opt-in email as spam to their Internet Service Provider (ISP) is up from 23.4% at the end of 2004 to nearly 34% at the end of 2005. The top reasons cited for the increase are lack of content relevancy and ratcheting up frequency beyond subscriber expectations. Moreover, according to a new Hostway survey, 70% of consumers said they would not purchase from websites that committed these pet peeves: pop-up advertising, registration log-on pages, software installation, and slow-loading pages. In addition, there is powerful evidence citing how effective email is when driving traffic to an online sale. In a recent Email Insider report, retailers who used email to promote post-holiday sales saw traffic increases of up to 700% above pre-holiday numbers.

Email deliverability will continue to be a major issue, and there are several deliverability challenges. Some, like authentication methods and challenge-response functionality, will be addressable by meeting technological specifications. But the most important factors affecting deliverability will continue to be reputation and respectful sending practices.

Furthermore, e-marketers' use of segmentation strategies and testing will become increasingly sophisticated. Marketers are getting smarter, and the technology is, too. Upcoming advances in email functionality like easier-to-use dynamic content, more robust testing capabilities, and deeper integration with web analytics providers will give businesses even more actionable information to drive sales and build relationships.

Additionally, there is a right and wrong way to build a list. A list is basically a database of subscribers. If a business wants to build an email marketing program, the best thing is not to purchase or borrow a list. Otherwise, they will be reported as a spammer. The best, most effective way to obtain a good list is to build it from the ground up. Building a database doesn't have to be difficult. In fact, it is one of the best ways to streamline marketing strategy to deliver measurable returns. In growing a quality permission—based list, the website is the best and most obvious place to build a list. If someone is surfing on the website, the business has a stellar opportunity to transform a web user from an interested party to a loyal patron. Usually there will be some link on the website that asks users to “Register Now” or “Subscribe Today” for a free e-newsletter, for more information, or for exclusive sales, offers and promotions. A survey page that is easy to fill out (name and email address are most important) is the next step. This information can then be used in a database.

The most time honored marketing method is word of mouth. Accordingly, using the current database to tell their friends about the business is a proven way to grow list. Using forward-to-a-friend and refer-a-friend tools, the audience will grow exponentially. These tools coupled with creative promotions such as special offers or drawings for those who refer friends, can build the subscriber base even more. But, as with any email marketing method, it must be used mindfully, employing permission-based methods only.

Great lists, like great buildings, are not built overnight. It takes time, often a few years, to grow a list that delivers big returns. A slowly built list ensures that users grow a community of patrons who rarely opt out. Email marketing campaigns are best implemented when integrated with and supported by other marketing efforts. That means the email marketing strategy should be part of printed collateral, in store and on-location promotions, advertising and trade show booth promotions. Every piece of paper about the business should include a link to the website and email subscription information.

The present invention provides a solution to these needs and other problems, and offers other advantages over the prior art.

### BRIEF DESCRIPTION OF THE DRAWINGS

FIG. 1 shows a navigation bar with tools, libraries, and dynamic fields tabs.

FIG. 2 shows a name and description field section.

FIG. 3 further shows a name and description field section with name and description added.

FIG. 4 illustrates a popup box for saving and naming a field in a folder.

FIG. 5 illustrates managing a previously created dynamic field.

FIG. 6 shows a view of a dynamic content library and subscriber segment section.

FIG. 7 shows a popup box for selecting subscriber segments.

FIG. 8 shows a create subscriber content section and a rules section.

FIG. 9 illustrates a popup box for inserting and formatting text.

FIG. 10 illustrates a view of a dynamic content library with stored fields.

FIG. 11 illustrates a navigation bar with messaging and retrieve message tabs.

FIG. 12 shows an initial portion of a rich text message composition page.

FIG. 13 shows a portion of a page with a text editor and dynamic content insert button.

FIG. 14 shows a portion of a page with a convert button for a text editor.

FIG. 15 shows the final portion of a page with a text editor.

### BRIEF SUMMARY OF THE INVENTION

In accordance with one embodiment of the invention, a computerized dynamic content system and method for use on the internet or other network is described. The ability to communicate personally with customers about products and services they are interested in is one of the most important advantages internet marketing offers over traditional channels. Dynamic content system and method makes mail messaging personal and relevant. The features enable easy, profitable engagement with customers using content, images and offers that correspond to their interests and behaviors. Moreover, dynamic content functionality lets the user send personalized messages to each group using a single email template. If customers and subscribers fall into multiple groups, a user or business user may choose to send them all content that is relevant or select which content gets served by order of importance. In addition they may develop content that matches the interests of subscriber lists. Dynamic content system and method also updates automatically as needs of the users and the demographics of the subscriber lists change.

Additional advantages and features of the invention will be set forth in part in the description which follows, and in part, will become apparent to those skilled in the art upon examination of the following or may be learned by practice of the invention.

### DETAILED DESCRIPTION

In accordance with one embodiment of the invention, a computerized dynamic content system and method for use on the internet or other network is described. The ability to communicate personally with customers about products and services they are interested in is one of the most important advantages internet marketing offers over traditional channels. Dynamic content system and method mail messaging personal and relevant. The feature enables easy, profitable engagement with customers using content, images and offers that correspond to their interests and behaviors. Moreover, dynamic content functionality lets the user send personalized messages to each group using a single email template. If customers and subscribers fall into multiple groups, a user or business user may choose to send them all content that is relevant or select which content gets served by order of importance. In addition they may develop content that matches the interests of subscriber lists.

For example, a user may create an offer on gas grills for outdoor cooking and a recipe for French cooking on a subscriber list. It will be understood that a subscriber list is one that internet marketers often utilize to gather customer email addresses. If subscribers fall into multiple groups, the user may choose to send them all relevant content, or select which content gets served by order of importance. Furthermore, the user may create a single email template containing any combination of dynamic fields and static fields. The system and method automatically personalizes each email based on the lists the subscribers belong to. Therefore, fans of outdoor cooking receive an offer for a gas grill, while French cooking enthusiasts get a recipe for duck á l'orange.

Additionally, another aspect of dynamic content system and method may help with the common problem of abandoned shopping carts. It will be understood by those skilled in the art that a shopping cart is a piece of software that acts as an online store's catalog and ordering process. Typically, a shopping cart is the interface between a company's web site and its deeper infrastructure, allowing consumers to select merchandise; review what they have selected; make necessary modifications or additions; and purchase the merchandise. Shopping carts can be sold as independent pieces of software so companies can integrate them into their own unique online solution, or they can be offered as a feature from a service that will create and host a company's e-commerce site. In a preferred embodiment, dynamic content system and method sends customers that have an abandoned shopping cart a personalized invitation or incentive to pick up where they left off in the checkout process. Furthermore, dynamic content system and method can track items that are discarded from a customer's shopping cart and then send them personalized emails with a special offer on the items they removed.

Furthermore, the problem of missed up-sell opportunities may be aided using dynamic content system and method. It will be understood by those skilled in the art that up-selling is to sell customers a higher-priced version of a product they have bought previously. The business can deploy dynamic content system and method in tandem with any event-triggered messaging capabilities and subscriber lists to schedule communications based on the sales cycle and the customer's service needs. Last but not least, slipping newsletter click-throughs is an issue that internet marketers and business users often have. By making newsletter content relevant with dynamic content system and method they will have a way of preventing this situation. The user may utilize a single email template to communicate personally with every member of a database by inserting customized fields based on subscriber demographics and actions. In a preferred embodiment, dynamic content system and method contains dynamic fields as a key component.

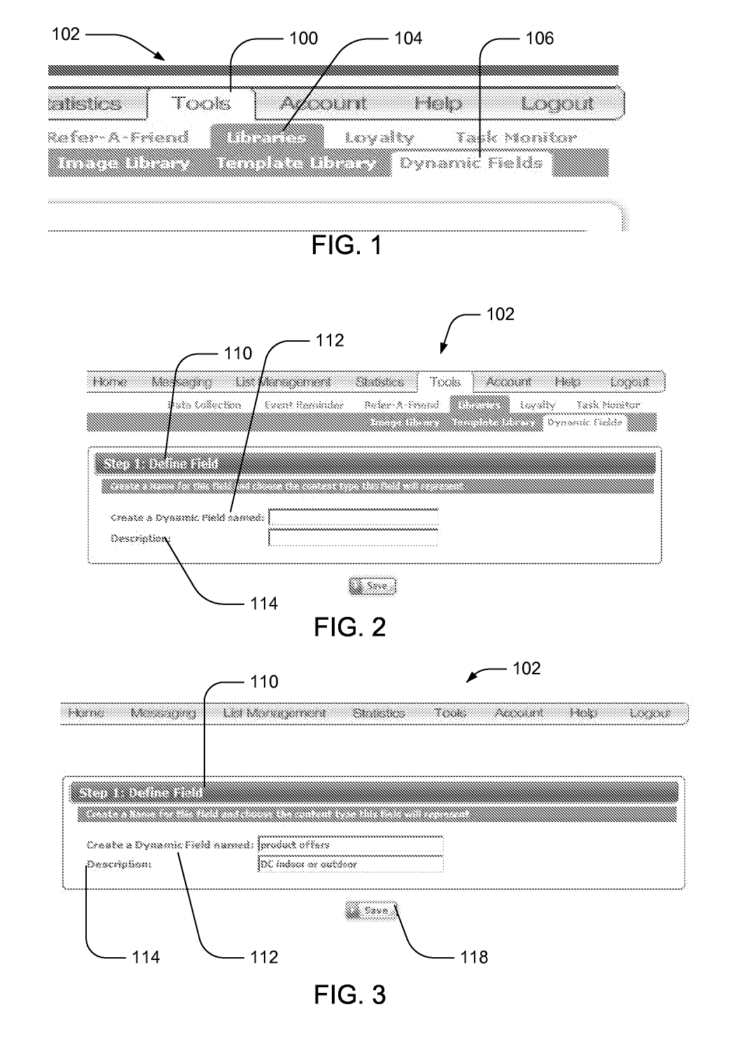

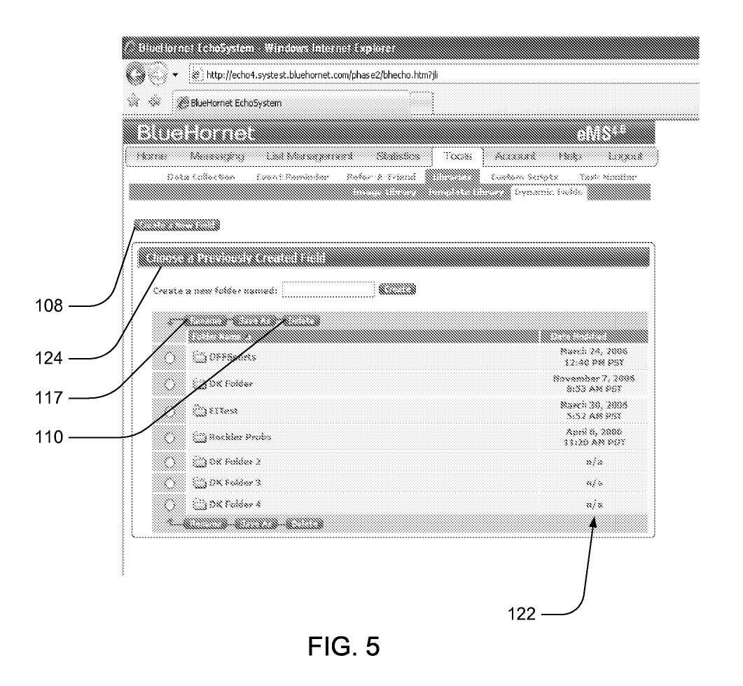

A user may first need to create dynamic content. Referring now to FIG. 1, the user would point the mouse to “tools” 100 in a navigation bar 102. Next the user would mouse over to “libraries” 104 and then click “dynamic fields” 106. FIG. 2 shows a screen that may follow after clicking on “dynamic fields” 106. Here, the user will click “create a new field” 108 (See FIG. 5, described below). Now the user will define a new field 110. The user will create a name 112 and a description 114 for the field 110 by entering the appropriate information in each of two boxes. The description is not required, but it is recommended in using it to provide additional information that will help develop appropriate content.

Referring now to FIG. 3, the user may name dynamic fields 110 that allow them to deliver product offers that correspond to a subscriber's cooking interests. It will be understood that any field name may be utilized and any description may be given depending on the user's needs. For example, in FIG. 3 the dynamic field 110 will be called “product offers” under the name 112. Accordingly, the user may add a description 114 that reminds them what specific data points the field 110 refers to. In this case, it may be “DC indoor or outdoor.” This reminds the user that this field 114 contains dynamic content for subscribers interested in indoor cooking or outdoor cooking. It will be understood that the user may be collecting data for these two areas.

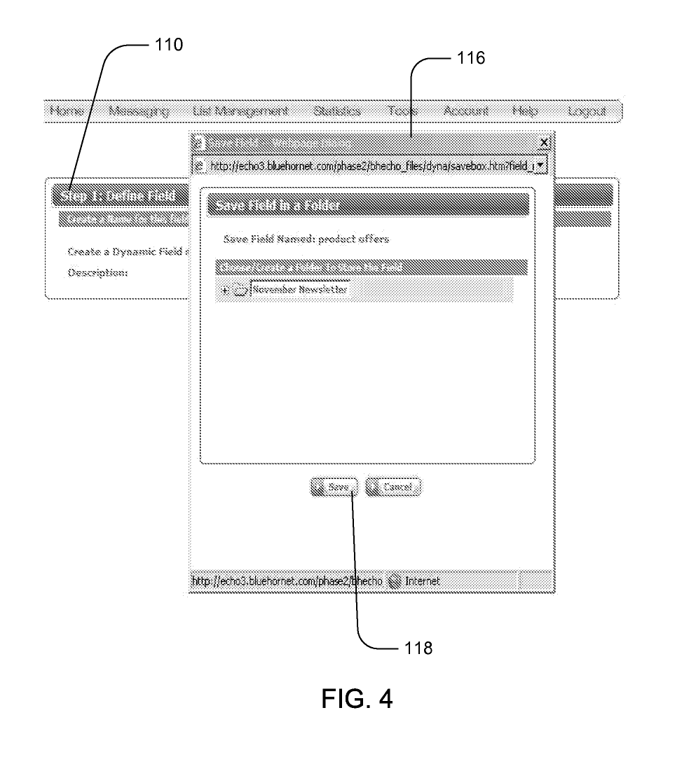

Once the user has named 112 and described 114 the field 110 they may create a folder to store the field 110. FIG. 4 shows a popup box that displays when the user clicks “save” 118. The user may utilize folders to group dynamic fields any way they wish. For instance, the user may group by a geographical region or an overall email campaign. However in most cases the user will want to create folders that correspond to a particular message. In that way the user will have dynamic content pieces for a particular message in the folder for that message. Therefore as shown in FIG. 4, the user may type a name of the folder, in this case “November Newsletter”, then click “save” 118.

Dynamic content system and method fields 110 and folders may also be managed by the user. FIG. 5 illustrates the “create a new field” 108 button the user may wish to utilize if they have previously created a dynamic field 110. Here, the user may “choose a previously created field” 124 from a list as shown. Furthermore, the user may rename 117 and/or delete 120 any folders. The folders are stored by date modified 122 for easy managing of dynamic content fields 110.

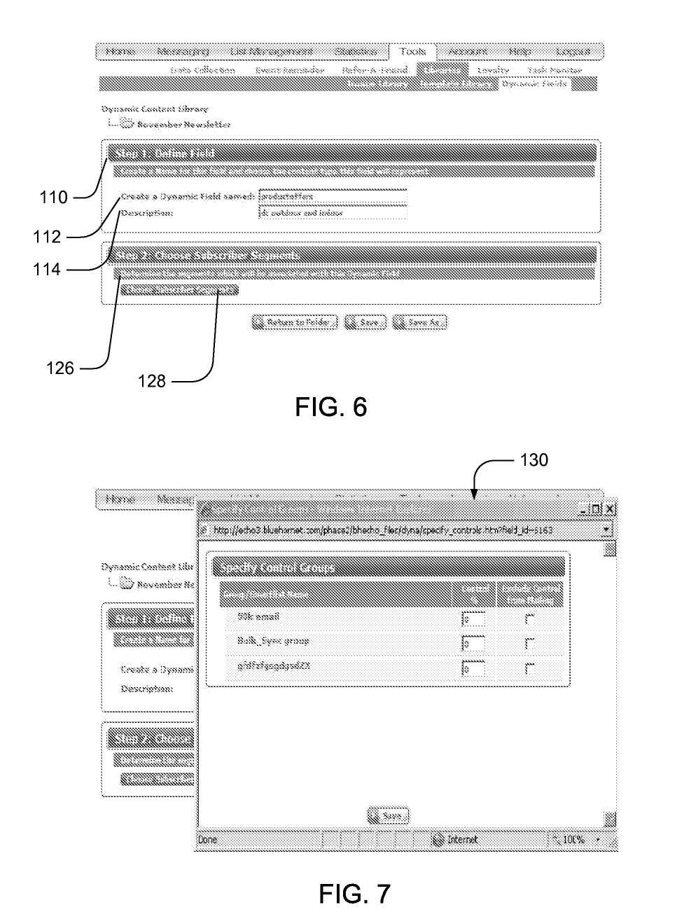

Moving on to FIG. 6, a box for “choosing subscriber segments” 126 in the folder created in FIG. 4 is shown. This asks the user to choose which subscribers will receive the customized content. They may select from groups they have previously created or from existing subscriber lists.

FIG. 7 shows the next screen following “choosing subscriber segments” 126 in FIG. 6. Once the user clicks “choose subscriber segments” 128, a popup box for selecting segments 130 appears. The user then selects all segments that apply and clicks “save” 118. Here the user may also control the percentages and exclude control on mailing messages.

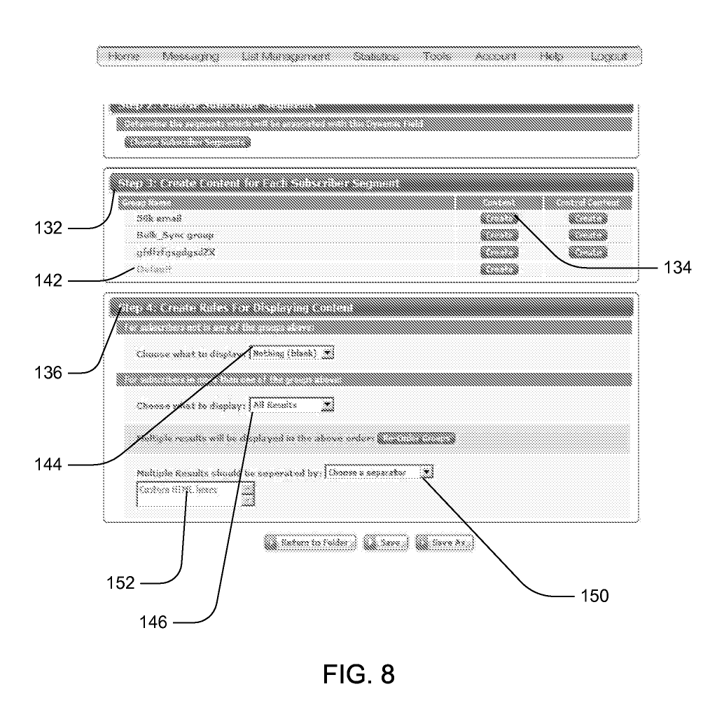

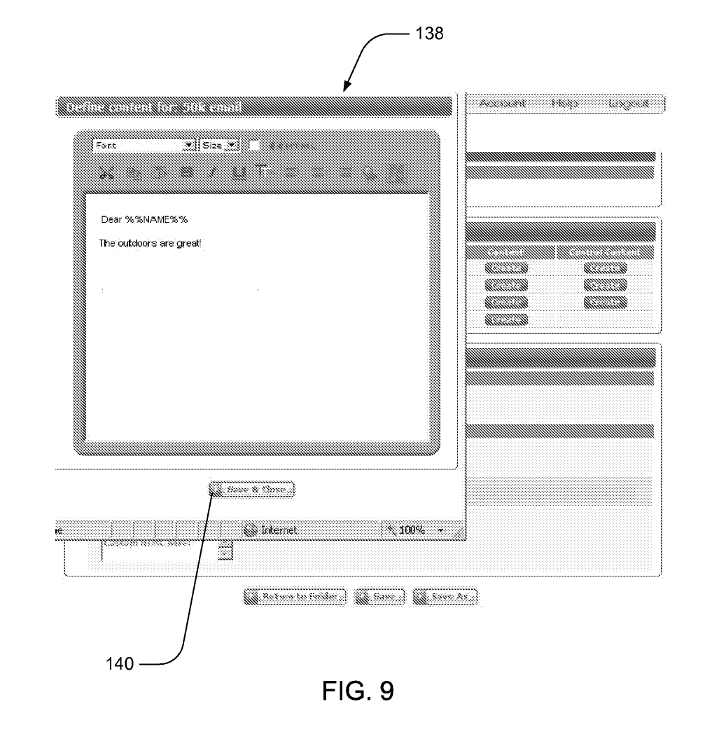

Referring to FIG. 8, the user will next create content for each subscriber segment. The user may click “create” 134 then use the rich text editor that appears in the pop-up window 138 for the content. As illustrated in FIG. 9, the user may copy and paste text into the window. They may also go to an image library to drop in an image that can then be hyperlinked or they can insert a hypertext markup language (HTML) code. When the user is finished with inserting the desired content, they may click “save and close” 140. The user may add more than one piece of content for each subscriber segment. For example, the user may plug in offers of gas grills as well as one for charcoal grills. The process is the same regardless of the number of dynamic content pieces attributed to each segment. Again referring to FIG. 9, the user may create text-only, America Online (AOL) and HTML dynamic content offers. These options are located in the popup box for defining content 138.

By way of an example, it will be understood that for an indoor cooking group, the message may include text for a “Braun Hand Blender: $29.99 is our first offer” and a “Grind and Brew Coffee Machine $189.99 is our second offer.” The user would click “save and close” 140 and then follow the same process for an outdoor cooking group. When they are finished, the folder will contain text counterparts to each of the HTML, text-only, or AOL dynamic content pieces.

Referring again to FIG. 8, it is important to note that there is a “default” 142 category that appears in list under “creating content for each subscriber segment” 132. The user will probably have subscribers that do not fit into any of the segments they have chosen. For example, the user may have subscribers who have not expressed an interest in either indoor cooking or outdoor cooking. For those subscribers, the user may want to create “default” 142 content that they will receive instead of dynamic content. Again for example, the user may create default content will be an offer for a hand blender and the gas grill.

Moreover, the user may utilize the dynamic content system and method for creating rules 136 for displaying dynamic content. The user may select from two options here. For example, they may choose to give subscribers no content in the place where the dynamic content would otherwise go, or they may choose to send them default content. This may be done under the “choose what to display” 144 section of the “creating rules for displaying content” 136. If subscribers fall into more than one segment, dynamic content system and method lets the user create specific rules 136 to determine what content will be delivered in those cases as well. For subscribers who fall into multiple categories, the user may choose to deliver all applicable dynamic content pieces to them by clicking “all results” 146 in the drop-down menu. Additionally, the user may send subscribers the top results or default content.

Also, to serve subscribers dynamic content for their top matches the user may need to rank the segments by order of importance. Using the example of indoor cooking and outdoor cooking, if the user chooses to display “top 1 result,” in the drop-down menu 146. Accordingly, those subscribers who have shown a preference for both types of cooking will only receive the dynamic content the user has developed for indoor cooking. Selecting “top 2 result” and they will receive both of the dynamic content pieces. And again, the user can choose to display default content to those subscribers who fall into both the indoor and outdoor cooking categories.

Still referring to FIG. 8, the user may re-order groups. The “re-order groups” button 148 gives the user the opportunity to rearrange the order of subscriber segments. This will have a direct affect on the rules they have created. If the user chose to deliver multiple dynamic content pieces they will want to determine how to separate each piece. The user may accomplish this by choosing a separator from the drop-down lists 150 or choosing “custom HTML” 152 and use the text box to create their own separator. Finally, once the user is satisfied they can click save or “save as,” which will allow them to save these dynamic content fields into another folder.

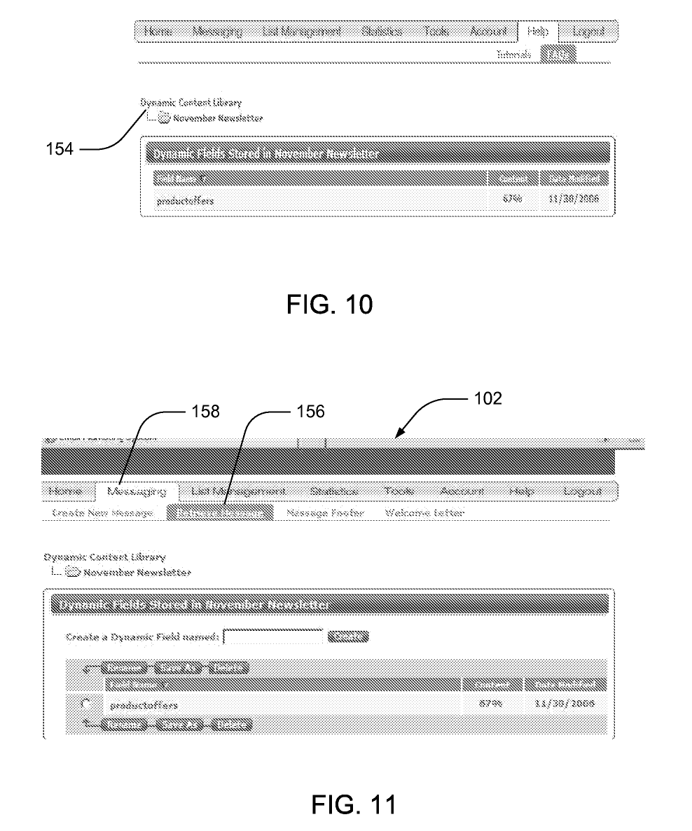

FIG. 10 illustrates the fields 110 stored in the “November Newsletter” and in a dynamic content library. This will deliver customized product offers to the November newsletter subscribers based on whether they've expressed an interest in indoor or outdoor cooking. However, if the user would like to deliver those subscribers a recipe that corresponds to their cooking preferences they will create another dynamic field 110 for recipes following the exact same process. This is just one of many ways to stack dynamic content pieces to further target subscribers' interests using a single email template.

Referring now to FIG. 11, the user may wish to send messages that include dynamic content by inserting dynamic fields 110. The user would go to “messaging” 158 in the navigation bar 102 and then click “retrieve message” 156 and then retrieve the appropriate message.

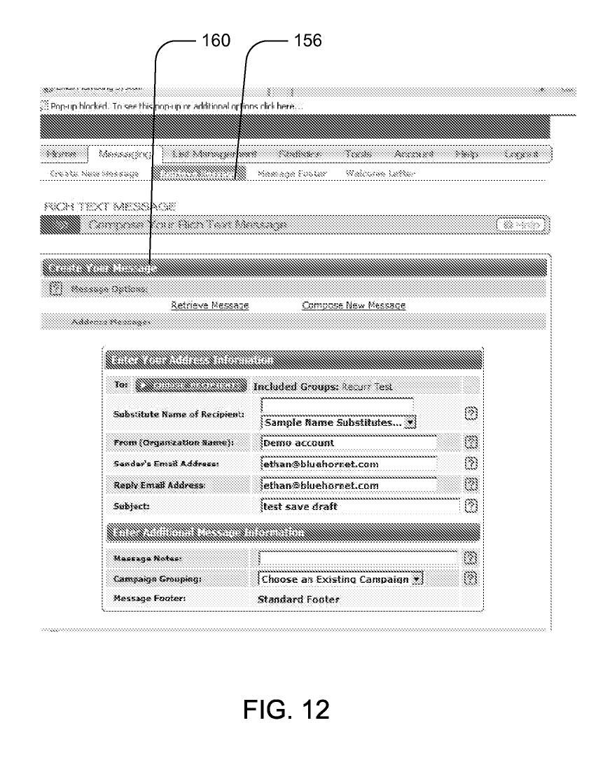

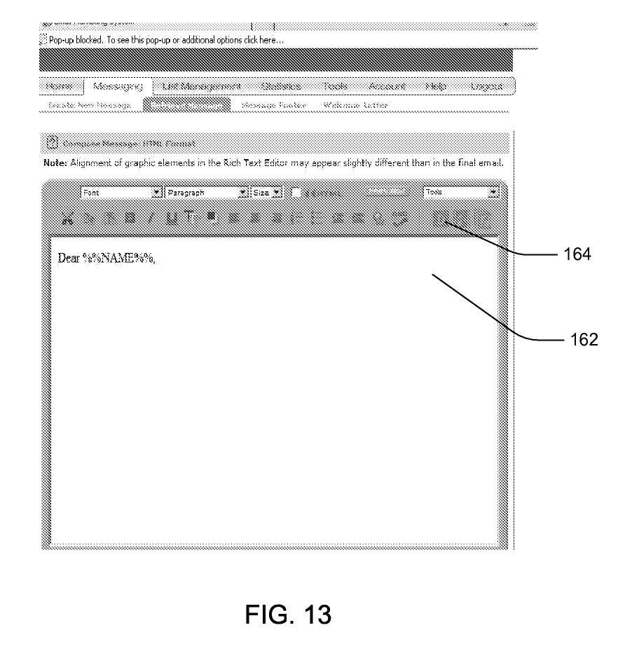

FIG. 12 shows a rich text message window 160. The user may also change recipients, substitute names of recipients, the organization name, the sender's email address and the reply email address. A subject may be added, along with additional message information such as message notes, campaign grouping, and message footers. The user would then scroll down to the rich text editor window 162, shown in FIG. 13. The user would then place the cursor in the place where they would like the dynamic content field 110 to be inserted and then click the dynamic field button 164 in the editor 162. In FIG. 13 it is shown as a letter “D.” It will be understood that the dynamic field button 164 is not limited to the configuration shown. The dynamic field 110 window will open (not shown). The user has the option to use an existing field or create a new field. It will be understood that the process for creating a new field from this window is exactly the same as creating a new field using the navigation bar 102 (See FIGS. 1 through 10).

For example, assume the user is using an existing dynamic field, such as the HTML version of a “product offer” field. Accordingly, the user will open up the “November Newsletter” folder, and then click “Product Offers.” This inserts the field right where they placed the cursor in the rich text editor 162. The user will notice that the content field was inserted because they will see “%%” for dynamic content, underscore, then the name of the message followed by “%%.”

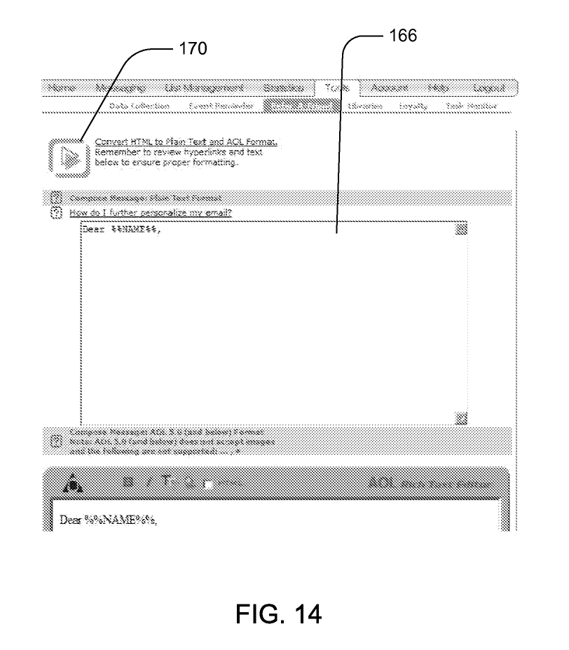

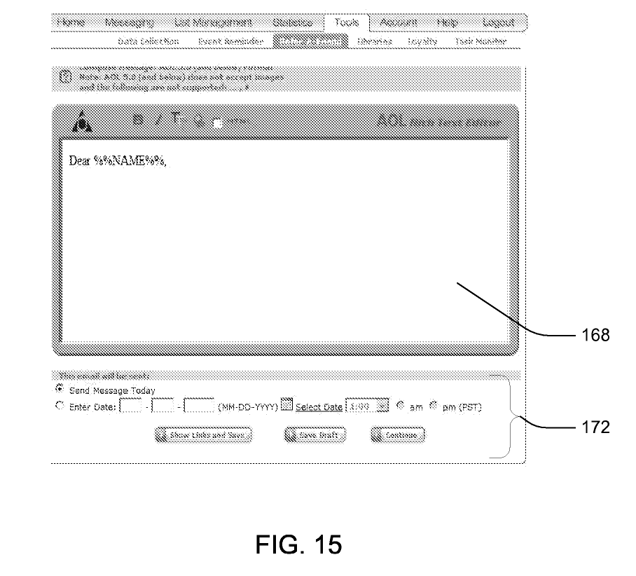

FIGS. 14 and 15 show the text—only 166 and AOL versions 168 of the editor 162. The user may click the “convert” 170 button which adds the HTML content fields to plain text and AOL messages. Then the user appends a %% dc_NAME %% code by adding the word “Text” immediately after the “s” in offers and before the first percent sign. The user then will save this and then scroll down to the scheduling of the message 172 (Shown in FIG. 15). After saving and continuing the message with dynamic content and dynamic fields will be ready. The user may then apply the dynamic content system and method to all of their marketing messages and campaigns. The dynamic content system and method will update automatically according to the subscriber list specifics (such as customer interests and behaviors).

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A computerized dynamic content system for use on a network, comprising:
a database having customer profile data where each customer record includes an email address and at least one of: a customer demographic, a preference setting, and a shopping behavior;
a software module operatively configured to dynamically set content of a personalized message based on the customer profile data; and
an email campaign manager operatively configured to send the personalized message to a customer over the network.

2. The dynamic content system of claim 1 wherein a user sets rules for displaying content of the personalized message.

3. The dynamic content system of claim 2 wherein a user may select a default rule or create a customized rule for displaying content of the personalized message.

4. The dynamic content system of claim 1 wherein the software module comprises an editor for creating dynamic content for the personalized message.

5. The dynamic content system of claim 4 wherein the editor is operatively configured to create dynamic content in a format selected from a group consisting of: plain text, rich text, hypertext markup language, and America Online.

6. The dynamic content system of claim 1 wherein the dynamically set content that is based on the customer profile data enables engagement with customers using content, images, and offers that correspond to the customers interests and behaviors such that purchase frequency is increased.

7. The dynamic content system of claim 2 wherein a user sets rule to send a customer a personalized message to encourage the customer to pick up where the customer left off in a checkout process based on a previously abandoned shopping cart.

8. The dynamic content system of claim 2 wherein a user sets a rule to send a customer a personalized message to encourage the customer to purchase an item based on a previously discarded item in a shopping cart.

9. A method for managing dynamic content of personalized messages for use on a network, comprising steps of:
storing customer profile data where each customer record includes an email address and at least one of: a customer demographic, a preference setting, and a shopping behavior;
dynamically setting content of a personalized message based on the customer profile data; and
sending the personalized message to a customer over the network.

10. The method of claim 9 further comprising a step of setting rules for displaying content of the personalized message.

11. The method of claim 10 wherein the setting rules step comprises selecting a default rule or creating a customized rule for displaying content of the personalized message.

12. The method of claim 9 further comprising a step of creating dynamic content for the personalized message.

13. The method of claim 12 wherein the creating step comprises creating dynamic content in a format selected from a group consisting of: plain text, rich text, hypertext markup language, and America Online.

14. The method of claim 9 wherein the dynamically setting step enables engagement with customers using content, images, and offers that correspond to the customers interests and behaviors such that purchase frequency is increased.

15. The method of claim 9 wherein the sending step comprises sending a customer a personalized message to encourage the customer to pick up where the customer left off in a checkout process based on a previously abandoned shopping cart.

16. The method of claim 9 wherein the sending step comprises sending a customer a personalized message to encourage the customer to purchase an item based on a previously discarded item in a shopping cart.
